(19) United States
(12) Patent Application Publication
(10) Pub. No.: US 2006/0180041 A1
(43) Pub. Date: Aug. 17, 2006

(54) Warp printer, weaving machine and weaving method

(76) Inventor: Hiroshi Kadota, Imabari-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/057,173

(22) Filed: Feb. 15, 2005

(51) Int. Cl. B41F 33/00

(52) U.S. Cl. 101/483

(57) ABSTRACT

The invention provides a warp printer, a weaving machine and a weaving method each having high freedom of a pattern to be expressed on a woven fabric and versatility to cope with production of woven fabrics of various kinds in limited quantities. A warp printer 1 includes yarn width reducing means 4 for reducing a width of warps 3 supplied from a warping bobbin 2, yarn width expanding means 8 disposed downstream of the yarn width reducing means 4, for expanding the yarn width reduced, an ink nozzle 6 interposed between the yarn width reducing means 4 and the yarn width expanding means 8 and ink nozzle moving means 7 for moving the ink nozzle 6 in a yarn width direction.

### BACKGROUND OF THE INVENTION

1. Field of the Invention

This invention relates to a weaving method of woven fabrics such as towel woven fabrics and a weaving machine used for the method.

2. Description of the Related Art

Methods for creating patterns on fabrics can be broadly divided into a yarn dyed fabric method that appropriately combines those yarns that are dyed in advance to a plurality of colors and weaves them into a fabric to express the patterns and a piece dyed fabric method that prints patterns after plain fabrics are woven.

The piece dyed fabric method that prints the plain fabric that is once woven has been widely employed. However, because this method must prepare an original for printing, the method is not profitable for the production of fabrics in a limited quantity. The method cannot readily satisfy those demands that have a short time limit for delivery because a long time is necessary to prepare the original after the design is decided. In the case of towel woven fabrics, in particular, a large number of small loops are formed on the surfaces by pile yarns. Therefore, the distal ends of the loops must be cut by a work called “shirring” in order to precisely print a pattern to a certain extent. This work increases the number of work steps. Generally, this method can print only one of the surfaces of the towel woven fabrics. Double-face printing can be theoretically made by repeating the printing step but such a method is troublesome to carry out and invites the increase of the cost of production. Another problem with this method is that the pile yarns the loop distal ends of which are cut are likely to fall off during the second printing. Therefore, double-face printing is hardly carried out in practice and almost all the towels produced by this method have the plain surface on the back.

In the case of the towel woven fabric, for example, the yarn dyed fabric method includes the steps of dyeing beforehand needle pile yarns and bobbin pile yarns to mutually different colors, taking up both yarns on warping bobbins and switching appropriately the needle pile yarns and the bobbin pile yarns while weaving is made by using a jacquard loom so that the pattern can be formed on the surface side of the towel. In other words, when the needle pile yarn appears on the surface, the color of the needle pile yarns is expressed at that point and when the bobbin pile yarn appears on the surface, the color of the bobbin pile yarn appears. The pattern is constituted by the combination of these colors. According to this method, when the needle pile yarn appears on the surface, the bobbin pile yarn appears on the back and the patterns of the surface and the back inevitably have a negative-positive relationship of one color and its inverted color. In other words, this method cannot form independent patterns on both surfaces. It is necessary in this method to prepare and fit warping bobbins of corresponding colors whenever the pattern is changed and to prepare a program for determining a switching sequence of the needle pile yarns and the bobbin pile yarns during weaving. Therefore, the period from the acceptance of an order to completion of the product is long and the production in a limited quantity does not pay easily.

Japanese Patent No. 2,952,542 discloses a production method of a towel woven fabric by using the dyed yarn method. This method involves the steps of paralleling non-seized pile warps into a sheet form by using a warping comb, conveying the warps by arranging dancer rollers upstream and downstream of a printing machine, for example, in such a manner that the parallelrows of the yarns are not disturbed, performing printing in a size of the pattern to be represented on a woven fabric elongated in a longitudinal direction at a magnification ratio corresponding to a contraction ratio of the yarns due to the pile formation, applying necessary processing such as baking, washing with water, soaping, seizing, etc, taking up the warps on a weaving beam, weaving a towel woven fabric from the pile warps subjected to warp printing, pile warps separately prepared and not subjected to warp printing, ground warps and wefts, forming a pile portion expressing the pattern based on warp printing by the pile warps subjected to warp printing on a surface of the woven fabric, and forming a pile portion with or without patterns on the opposite surface of the pile portion from the pile warps not subjected to warp printing.

The technologies according to the prior art, whether they may be the method that performs printing after weaving of a fabric or the method that constitutes a pattern by up-down inversion of the dyed pile yarns, need a large number of process steps and are very time-consuming. Therefore, these methods cannot easily meet with orders requiring a short time limit of delivery and cannot either express freely independent patterns on both surfaces.

The production method of the towel woven fabric disclosed in the patent document described above cannot independently express mutually different patterns on both surfaces, either. To execute this method, it is essentially necessary to take up the yarn sheet on the weaving beam after the yarn sheet is printed and to correctly feed the yarns lest all the pile yarns deviate from one another until the pile yarns are taken out and are woven. When any deviation occurs, the pattern undergoes deformation and gets obscured. Nonetheless, strict management of the yarn feed is not made in existing looms and this method cannot be easily put into practical application.

### SUMMARY OF THE INVENTION

It is therefore an object of the invention to provide a warp printer, a weaving machine and a weaving method each having high freedom of patterns to be expressed on a fabric by using a simple apparatus and simple production steps and having high versatility.

To accomplish this object, the warp printer according to the invention includes warp width reducing means for reducing a width of warps supplied from a warping bobbin; warp width expanding means disposed downstream of the warp width reducing means, for expanding the width of the warps reduced; an ink nozzle interposed between the warp width reducing means and the warp width expanding means; and ink nozzle moving means for moving the ink nozzle in a warp width direction.

The weaving machine according to the invention has the warp printer described above. The warp printer described above may be arranged for pile yarns for the application as a towel weaving machine. Furthermore, the warp printers may be arranged for both needle pile yarns and bobbin pile yarns, respectively.

The weaving method according to the invention reduces a width of warps supplied from a warping bobbin, jets ink to the warps and prints the warps by moving an ink nozzle in a warp width direction downstream of the warping bobbin, expands the width of the warps so printed to a width necessary for a woven fabric and weaves the warps. The weaving method of a towel woven fabric may also include the steps of reducing a width of pile yarns supplied from a warping bobbin; jetting ink to the pile yarns and printing the pile yarns by moving an ink nozzle in a yarn width direction downstream of the warping bobbin; expanding the width of the pile yarns so printed to a width necessary for a woven fabric; and weaving the pile yarns printed. The weaving method may further include the steps of reducing widths of needle pile yarns and bobbin pile yarns, respectively; independently jetting ink to the needle pile yarns and to the bobbin pile yarns and printing both of the needle pile yarns and the bobbin pile yarns by moving an ink nozzle in a yarn width direction downstream of the warping bobbins; expanding the widths of the needle pile yarns and the bobbin pile yarns so printed to widths necessary for a woven fabric, respectively; and weaving both of the pile yarns printed to a towel woven fabric. Still alternatively, the weaving method may include the steps of reducing a width of bobbin yarns supplied from a warping bobbin; jetting ink to the bobbin yarns by moving an ink nozzle in a yarn width direction downstream of the warping bobbin and printing the bobbin yarns; expanding the width of the bobbin yarns printed to a width necessary for a woven fabric; and weaving the yarns printed to a towel woven fabric.

The woven fabric according to the invention is woven by the weaving methods described above. The towel woven fabric is a woven fabric in which independent patterns are expressed on the needle pile yarns, the bobbin pile yarns and the bobbin yarns.

Although the invention dyes the warps before weaving and expresses the pattern on the woven fabric, the invention can accomplish the warp printer, the weaving machine and the weaving method each having high freedom of the pattern to be expressed on the fabric and having versatility by using a simple apparatus and simple process steps.

### BRIEF DECRIPTION OF THE DRAWINGS

FIG. 1 is an explanatory view showing a warp printer; and

FIG. 2 is an explanatory view showing an embodiment of the warp printer.

### DESCRIPTION OF THE PREFERRED EMBODIMENT

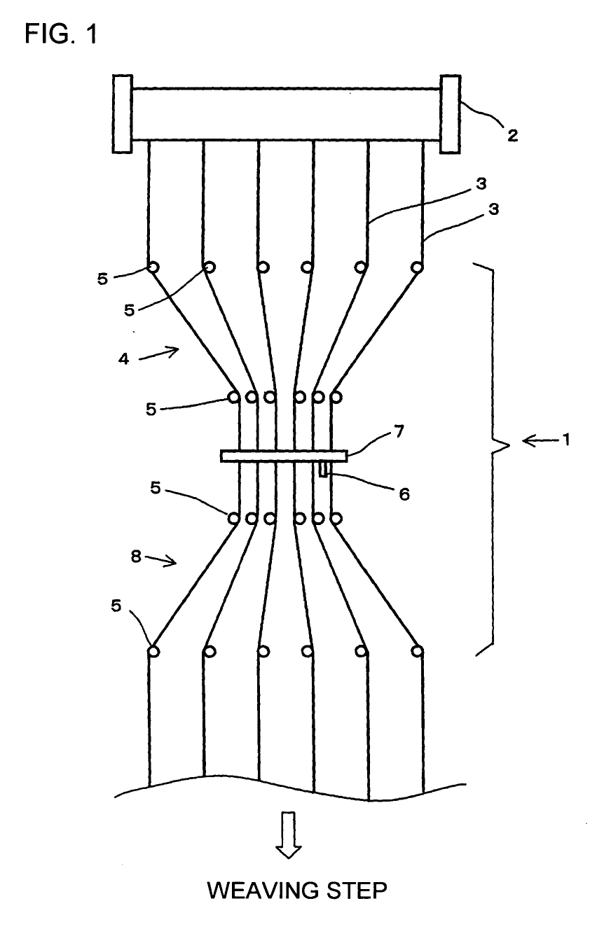

An embodiment for practicing the invention will be explained with reference to the accompanying drawings. FIG. 1 is an explanatory view showing a warp printer according to the invention. The warp printer 1 is interposed between a warping bobbin 2 and a woven fabric main body portion. The warp printer 1 includes warp width reducing means 4 for reducing a width of warps 3 supplied from the warping bobbin 2. The warp width reducing means 4 has a plurality of warp guides 5 arranged with predetermined gaps between them. The warps 3 supplied from the warping bobbin 2 enter the warp width reducing means 4 with a warp width substantially corresponding to the winding width of the warping bobbin 2 and are gathered into a reduced width while being guided by the row of warp guides 5. In this embodiment, only one warp width reducing means 4 is disposed and the warps 3 are gathered to a predetermined width by one process step. However, it is also possible to arrange a plurality of warp width reducing means 4 in multiple stages and to reduce the warp width into the predetermined width in a plurality of warp width reducing steps.

An ink nozzle 6 and ink nozzle moving means 7 for moving the ink nozzle 6 in a warp width direction are arranged downstream of the warp width reducing means 4. Dye is jetted from the ink nozzle 6 to the warps and dyes them.

When the warps extended from the warping bobbin are as such dyed in a broad warp width without arranging the warp width reducing means 4, it is necessary to dispose ink nozzle moving means covering the warp width and to move the ink nozzle at an extremely high speed. However, it is very difficult to let the ink nozzle follow the movement of the woven fabric because the moving speed of the woven fabric has become very high due to development of weaving technologies. When the woven fabric is dyed while the warps keep the broad warp width, the warp density is low and only a limited amount of the dye consumed is used for dyeing while the major proportion is wasted. Moreover, the dye adheres to the distal end and peripheral portions of the ink nozzle and contaminates the warps.

Because the warp printer 1 according to the invention reduces the warp width by the warp width reducing means 4, the ink nozzle moving means may well be compact in scale. Moreover, because the moving time can be reduced, the warp printer 1 can be easily adapted to a high speed weaving process. Because printing is made while the warps are gathered in a high density, the dye consumed can be effectively used for dyeing.

A controller 9 controls the ink nozzle 6 and the ink nozzle moving means. Controllers for ordinary printers for paper printing and control programs for such printers can be used for this purpose. In this case, printing can be quickly carried out by taking an original into a computer by using an image scanner and executing an image processing for lowering resolution, whenever necessary, and simplifying the process to a certain extent.

Dyeing is made in the manner described above to constitute a desired pattern when the warps 3 are woven into a woven fabric. The warps so dyed are sent to warp width expanding means 8 disposed on the further downstream side. The warp width expanding means 8 operates in the opposite way to the warp width reducing means 4 described above and includes warp guides 5 disposed with predetermined gaps between them. The width of the warps 3 that are paralleled is expanded to a width necessary for the weaving step. Only one warp width expanding means 8 may be arranged. Alternatively, a plurality of warp width expanding means 8 may be arranged in multiple stages to expand a plurality of times the width of the warps 3 paralleled to a predetermined width. After expanded to the width necessary for the weaving step, the warps are sent to the weaving step and are woven to a woven fabric. Because the warps 3 that have already been dyed to express the pattern are as such sent to the weaving main body portion of the weaving machine and are woven into the woven fabric, a precise pattern can be expressed on the surface of the woven fabric.

Various looms such as a rapier loom, a jacquard loom, air jet loom, and so forth, can be used for the woven fabric main body portion. When weaving is made at the same continuous pile length (parallel piles) as described above, a scheduled pattern appears on the woven fabric. Therefore, it is not necessary to deliberately use the jacquard loom and to conduct a complicated switching operation of the warps. Because the method of the invention can be executed by merely adding and interposing the warp printer 1 between the warping bobbin and the woven fabric main body portion, the method of the invention can be easily introduced without calling for large changes of existing equipment and processes.

The pattern of the woven fabric is created by dyeing from the ink nozzle. Therefore, the warp as the starting material may be only a white warp. To change the pattern, too, it is only necessary to input data of a new pattern to the controller 9 that controls the ink nozzle 6 and the ink nozzle moving means 7, and a troublesome operation such as the exchange of the warping bobbin that is time consuming and gives a large burden is not necessary. Because complicated process steps of the prior art dyed yarn method that dyes in advance a delicate and soft wound package and conducts de-sizing can be eliminated, the quantities of water and energy can be drastically reduced and the burden to the environment is small. Because the warps subjected to warping can be fully used up, the invention is preferable from the aspect of the effective utilization of resources. Furthermore, production in a limited quantity is possible, too. For example, production of only one sheet or only one row can be made at a relatively low cost of production. Woven fabrics having different patterns can be produced without stopping the production line by continuously supplying data of the different patterns to the controller 9. It is further possible to print a serial number to each gift towel and to print the name of a customer when the towels are used as a gift towel to the customers.

### Example 1

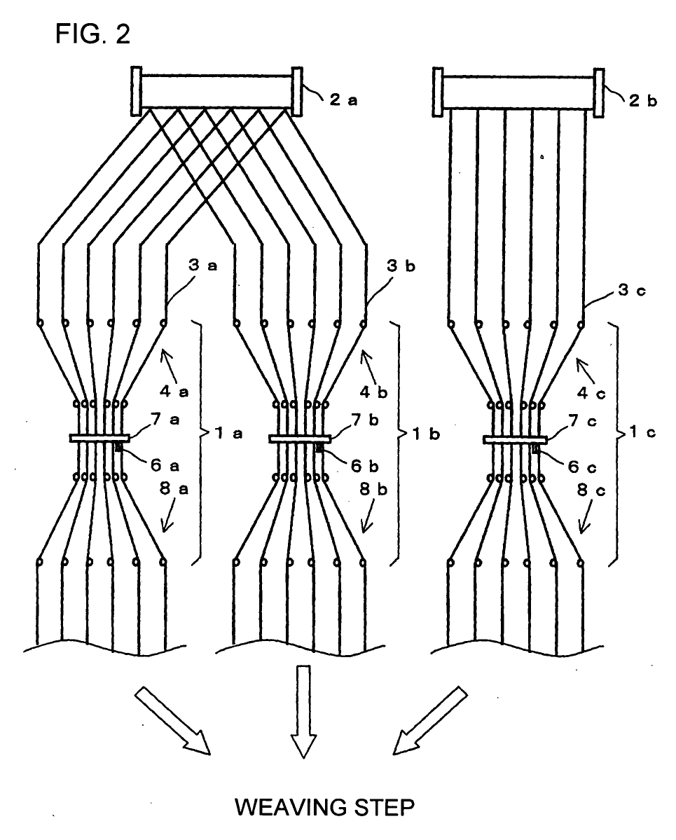

This invention can be applied to printing of warps of an ordinary woven fabric such as plain weave and to a towel woven fabric as is dealt with in this example. This example will be explained with reference to FIG. 2. In this example, there are arranged a warping bobbin 2a on which pile yarns are wound and a warping bobbin 2b on which bobbin yarns are wound. The yarns on the warping bobbin 2a are divided into needle pile yarns 3a and bobbin pile yarns 3b.

A warp printer 1a is arranged on a yarn handling area of the needle pile yarns. In other words, the warps in the invention include pile yarns for a towel woven fabric. The needle pile yarns 3a are sent to an ink nozzle 6a and ink nozzle moving means while their width is reduced by warp width reducing means 4a. A dye is jetted to the needle pile yarns and dyes the warps so as to constitute the pattern of the surface of the towel. In this example, in particular, dyeing is conducted in match with the length of the pile yarns. The width of the needle pile yarns 3a dyed in this way is expanded to a width necessary for a weaving step by warp width expanding means 8a and the warps are fed to the weaving step. The pattern depicted by the warp printer 1a appears on the surface of the towel woven fabric woven by the dyed needle pile yarns 3a so dyed. Without employing a jacquard loom in the weaving step, the pattern can be applied to the towel by use of a dobby.

In this example, a warp printer 1b is separately arranged on the yarn handling area of the bobbin pile yarns 3b, too. Therefore, dyeing for constituting the pattern can be applied to the bobbin pile yarns 3b, too. Because the warp printer 1a for the needle pile yarns 3a and the warp printer 1b for the bobbin pile yarns 3b are independent from each other, mutually different patterns can be printed. In this case, the mutually different patterns are independently expressed on the top surface and back surface of the resulting towel woven fabric. Towels having entirely different patterns on both surfaces thereof have not yet been available. It is of course possible to let the both warp printers 1a and 1b print the same pattern. When the both warp printers 1a and 1b are controlled so that the colors of the bobbin pile yarns and the needle pile yarns are always opposite, a pattern having a negative-positive relation on the top surface and back surface can be expressed in the same way as a weaving method of the prior art that switches the colors of the bobbin pile yarns and the needle pile yarns. A sample can be provisionally produced by the method of this example before mass-production is made by the prior art method.

In this example, a warp printer 1c is further arranged on the yarn handling area of a bobbin pile yarns 3c. Therefore, dyeing can be applied also to the bobbin pile yarns 3c and freedom of the patterns of the towel woven fabric can be further improved.

The invention can be utilized as a novel weaving method capable of freely constituting a pattern of a woven fabric. The method of the invention can be easily introduced without great modification of existing production equipment and production processes. The woven fabric so produced can be utilized as a novel towel fabric having different patterns on both surfaces thereof, for example.

1. A warp printer comprising:
warp width reducing means for reducing a width of warps supplied from a warping bobbin;
warp width expanding means disposed downstream of said warp width reducing means, for expanding the width of the warps reduced;
an ink nozzle interposed between said warp width reducing means and said warp width expanding means; and
ink nozzle moving means for moving said ink nozzle in a warp width direction.

2. A weaving machine having said warp printer according to claim 1.

3. A weaving machine having said warp printer according to claim 1 for pile yarns.

4. A weaving machine having said warp printers according to claim 1 for needle pile yarns and bobbin pile yarns, respectively.

5. A weaving machine having said warp printers according to claim 1 for needle pile yarns, bobbin pile yarns and bobbin yarns, respectively.

6. A weaving method comprising the steps of:
reducing a width of warps supplied from a warping bobbin;
jetting ink to said warps and printing said warps by moving an ink nozzle in a warp width direction downstream of said warping bobbin;
expanding the width of said warps so printed to a width necessary for a woven fabric; and
weaving said warps printed.

7. A weaving method of a towel woven fabric comprising the steps of:
reducing a width of pile yarns supplied from a warping bobbin;
jetting ink to said pile yarns and printing said pile yarns by moving an ink nozzle in a yarn width direction downstream of said warping bobbin;
expanding the width of said pile yarns so printed to a width necessary for a woven fabric; and
weaving said pile yarns printed.

8. A weaving method comprising the steps of:
reducing widths of needle pile yarns and bobbin pile yarns supplied from warping bobbins, respectively;
independently jetting ink to said needle pile yarns and said bobbin pile yarns and printing said needle pile yarns and said bobbin pile yarns by moving an ink nozzle in a yarn width direction downstream of said warping bobbin;
expanding the widths of said needle pile yarns and said bobbin pile yarns so printed to widths necessary for a woven fabric, respectively; and
weaving both of said pile yarns printed to a towel woven fabric.

9. A weaving method according to claim 7, comprising the steps of:
reducing the width of said bobbin yarns supplied from said warping bobbin;
jetting ink to said bobbin yarns by moving an ink nozzle in a yarn width direction downstream of said warping bobbin and printing said bobbin yarns;
expanding the width of said bobbin yarns printed to a width necessary for a woven fabric; and
weaving said bobbin yarns to a towel woven fabric.

10. A woven fabric woven by said weaving method according to claim 6.

11. A towel woven fabric having patterns independently expressed on needle pile yarns, bobbin pile yarns and bobbin yarns.

12. A weaving method according to claim 8, comprising the steps of:
reducing the width of said bobbin yarns supplied from said warping bobbin;
jetting ink to said bobbin yarns by moving an ink nozzle in a yarn width direction downstream of said warping bobbin and printing said bobbin yarns;
expanding the width of said bobbin yarns printed to a width necessary for a woven fabric; and
weaving said bobbin yarns to a towel woven fabric.

13. A woven fabric woven by said weaving method according to claim 7.

14. A woven fabric woven by said weaving method according to claim 8.

15. A woven fabric woven by said weaving method according to claim 9.
